(19) United States
(12) Patent Application Publication
(10) Pub. No.: US 2007/0284937 A1
(43) Pub. Date: Dec. 13, 2007

(54) Brake system for a hybrid motor vehicle, method for maintaining the functionality thereof, and associated control device

(75) Inventors: Mathias Deiml, Donaustauf (DE); Florian Gutknecht-Stohr, Regensburg (DE); Roland Herfurth, Regensburg (DE); Frank Hofel, Regensburg (DE); Wei-Lung Lee, Regensburg (DE); Martin Rampeltshammer, Regensburg (DE); Matthias Tons, Regensburg (DE)

Correspondence Address: LERNER GREENBERG STEMER LLP, P O BOX 2480, HOLLYWOOD, FL, 33022-2480, US

(73) Assignee: Siemens Aktiengesellschaft

(21) Appl. No.: 11/818,423

(22) Filed: Jun. 13, 2007

(30) Foreign Application Priority Data
Jun. 13, 2006 (DE) 10 2006 027 387.7

(51) Int. Cl. B60T 8/44

(52) U.S. Cl. 303/115.3; 303/114.3

(57) ABSTRACT

In a brake system for a hybrid motor vehicle, while it is set to pure electric drive mode, the crankshaft of the combustion engine is driven temporarily with the aid of at least one electric motor for generating reduced pressure in the intake manifold for supplying reduced pressure of the additional vacuum reservoir to the vacuum chamber of its brake booster only when, during or following the single or multiple actuation of the brake pedal thereof, the reduced pressure in the vacuum reservoir of the brake booster drops to a predeterminable lower limit or falls below the lower limit.

### CROSS-REFERENCE TO RELATED APPLICATION

This application claims the priority, under 35 U.S.C. § 119, of German patent application DE 10 2006 027 387.7, filed Jun. 13, 2006; the prior application is herewith incorporated by reference in its entirety.

### BACKGROUND OF THE INVENTION

### Field of the Invention

The invention relates to a brake system with a brake booster for a hybrid motor vehicle. The hybrid vehicle has at least one combustion engine with an intake manifold and at least one electric motor for driving its powertrain.

In a motor vehicle which has only a combustion engine as sole drive source, the reduced pressure in the intake manifold of the combustion engine is in practice normally used during its combustion mode to load the vacuum chamber of the brake booster of a hydraulic/mechanical brake system. In the process, the intake manifold is always connected via a vacuum line to the vacuum chamber of the brake booster once the brake pedal of the brake system is actuated. This ensures boosting of the mechanical pedal pressure of the brake pedal in the brake booster and thus a smooth dosing of the brake power of the brake system overall.

### SUMMARY OF THE INVENTION

It is accordingly an object of the invention to provide a brake system which overcomes the above-mentioned disadvantages of the heretofore-known devices and methods of this general type and which provides for a hybrid motor vehicle which has at least one combustion engine and at least one electric motor for driving its powertrain and a hydraulic/mechanical brake system with a brake booster which continues to function in all drive states of the hybrid vehicle with reduced pressure.

With the foregoing and other objects in view there is provided, in accordance with the invention, a brake system with a brake booster for a hybrid motor vehicle having at least one combustion engine with an intake manifold and at least one electric motor for driving a powertrain of the motor vehicle, comprising:

at least one additional vacuum reservoir for a vacuum chamber of the brake booster;

at least one electric motor for subjecting the at least one additional vacuum reservoir to reduced pressure via at least one vacuum line of the intake manifold by temporarily driving the crankshaft of the combustion engine when combustion mode is deactivated and the hybrid vehicle is in pure electric drive mode, said at least one electric motor generating the reduced pressure in the intake manifold only when a reduced pressure in the vacuum reservoir of the brake booster drops to a predetermined lower limit or falls below the lower limit during or following single or multiple actuation of the brake pedal.

In other words, the objects of the invention are achieved according to the invention in a brake system of the type specified in the introduction in that at least one additional reservoir is provided for the vacuum chamber of the brake booster and in that, to subject this additional vacuum reservoir to reduced pressure via at least one vacuum line of the intake manifold, the crankshaft of the combustion engine, when combustion mode is deactivated, is temporarily driven in pure electric drive mode of the hybrid vehicle by at least one electric motor for generating reduced pressure in the intake manifold only when, during or after single or multiple actuation of the brake pedal thereof, the reduced pressure in the vacuum reservoir of the brake booster drops to a predetermined lower limit or falls below said lower limit.

Thus, in pure electric drive mode of the hybrid vehicle, to maintain the functioning, i.e. fault-free boosting of the braking power of the brake booster, the crankshaft of the deactivated combustion engine is only ever temporarily driven with the aid of at least one electric motor when, during or after single or multiple actuation of the brake pedal thereof, the reduced pressure in the additional vacuum reservoir which is assigned to the vacuum chamber of the brake booster drops to a predeterminable lower limit or falls below said lower limit. For the electromotively active rotation of the crankshaft of the combustion engine in pure electric drive mode of the hybrid vehicle, i.e. when the combustion mode of the combustion engine is deactivated, generates, if required, reduced pressure in the intake manifold thereof such that the vacuum reservoir for the brake booster can be resupplied by the intake manifold via the at least one vacuum line with reduced pressure for adequate brake boosting. Since the electric motor for temporarily driving the crankshaft of the combustion engine during the deactivated combustion mode thereof is activated only if required, i.e. only when, during or after single or multiple actuation of the brake pedal thereof, the reduced pressure in the respective vacuum reservoir of the brake booster drops to a predetermined lower limit or falls below said lower limit, a low energy input is sufficient for maintaining the functioning of the hydraulic/mechanical brake booster.

In this way, the combustion engine is operated in the pure electric drive mode of the hybrid vehicle with the aid of an electric machine in the manner of a vacuum pump or reduced-pressure pump which, to effect adequate brake boosting, sucks air from the additional vacuum reservoir of the brake booster if required. In the brake system according to the invention, it is consequently not necessary to install an additional electric vacuum or reduced-pressure pump in the intake manifold or in the brake booster itself which would always be activated if there were inadequate reduced pressure in the brake system. In particular, to generate brake pressure in the brake line, a so-called active brake booster with an additional electric vacuum pump which would additionally require a brake simulator for the back-pressure in the brake pedal, is not necessary. By comparison, the brake system for the hybrid motor vehicle according to the invention manages with simple, conventional components which are in any case already available for the hydraulic/mechanical brake system, as a result of which savings in weight, production/installation cost and fuel emerge.

If the first electric motor, in particular the integrated starter generator of the hybrid vehicle, which serves to apply torque to the powertrain, is operated in particular regeneratively in the respective braking process of the hybrid vehicle for converting brake power into electrical energy, then it is advantageous to make available portions of this recuperatively reclaimed energy directly to a second electric motor, in particular a belt-driven starter generator, for temporarily driving the crankshaft of the combustion engine if, in the event of an excessive exhaustion, i.e. decrease or reduction of the reduced pressure or vacuum in the vacuum reservoir, it becomes necessary to resupply the vacuum reservoir with reduced pressure from the intake manifold. This is advantageously particularly energy-efficient because energy losses are largely avoided. Alternatively, the electric motor for temporarily driving the crankshaft can utilize in the respective braking process portions of the electrical energy of an electrical energy storage device such as e.g. a battery which, during the braking process in the generator-operating mode of the particular electric motor which serves to drive the powertrain electromotively, has been recuperatively loaded into said store. In general terms, during the period in which the electric motor acts in a brake-like fashion for the powertrain as a generator and produces electrical energy recuperatively or regeneratively, sufficient electrical energy is thus available in an efficient manner for driving the electric motor for the temporary auxiliary driving of the crankshaft of the combustion engine when the internal pressure in the respective reduced-pressure or vacuum reservoir of the brake booster exceeds an upper limit, i.e. the reduced pressure there becomes too low.

The invention also relates to a method for maintaining the functioning of a brake system with a brake booster for a hybrid motor vehicle which has at least one combustion engine with an intake manifold and at least one electric motor for driving its powertrain, which method is wherein at least one additional vacuum reservoir for the vacuum chamber of the brake booster is subjected to reduced pressure when combustion mode is deactivated in the pure electric drive mode of the hybrid vehicle only when, during or after single or multiple actuation of the brake pedal thereof, the reduced pressure in the additional vacuum reservoir of the brake booster drops to a predetermined lower limit or falls below said lower limit, via at least one vacuum line from the intake manifold by virtue of the fact that the crankshaft of the combustion engine is temporarily driven by at least one electric motor for generating reduced pressure in the intake manifold.

Furthermore, the invention also relates to a control device for maintaining the functioning of a brake system for a hybrid motor vehicle which has at least one combustion engine with an intake manifold and at least one electric motor for driving its powertrain, which control device is wherein control means are provided, with the aid of which at least one additional vacuum reservoir for the vacuum chamber of the brake booster is subjected to reduced pressure when combustion mode is deactivated in the pure electric drive mode of the hybrid vehicle only when, during or after single or multiple actuation of the brake pedal thereof, the reduced pressure in the additional vacuum reservoir of the brake booster drops to a predetermined lower limit or falls below said lower limit, via at least one vacuum line from the intake manifold, by virtue of the fact that the crankshaft of the combustion engine is driven only temporarily by at least one electric motor for generating reduced pressure in the intake manifold.

Other features which are considered as characteristic for the invention are set forth in the appended claims.

Although the invention is illustrated and described herein as embodied in brake system for a hybrid motor vehicle, associated method for maintaining the functioning thereof and associated control device, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the-following description of specific embodiments when read in connection with the accompanying drawings.

### BRIEF DESCRIPTION OF THE SEVERAL VIEWS OF THE DRAWINGS

FIG. 1 is a schematic diagram of a hybrid motor vehicle with an exemplary embodiment of an inventive hydraulic/mechanical brake system which has a brake booster;

FIG. 2 is a schematic representation showing different braking modes of the brake system according to FIG. 1 as a function of different drive modes of the drive units of the hybrid vehicle, of the internal pressure of the additional vacuum reservoir for the brake booster of the hydraulic/mechanical brake system from FIG. 1 and of the executed pedal position of the brake pedal thereof; and

FIG. 3 shows a schematic reduced-pressure/time diagram which indicates by way of example how, depending on the current reduced pressure in the additional vacuum reservoir of the brake booster from FIG. 1, according to a variant of the method according to the invention, the functioning thereof can also be maintained in the pure electric drive mode of the hybrid vehicle.

### DETAILED DESCRIPTION OF THE INVENTION

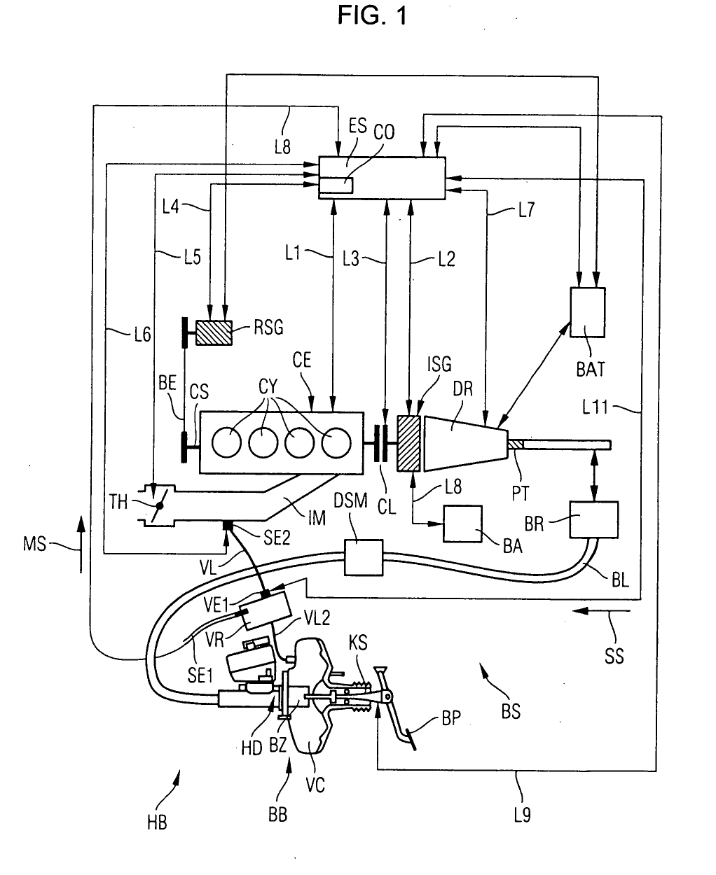

Referring now to the figures of the drawing in detail in which corresponding and functionally equivalent elements are identified with the same reference characters throughout, and first to FIG. 1, there is shown a schematic of the main components of a powertrain PT for a hybrid motor vehicle HB, namely, the drive sources or drive units together with an example of a brake system BS which operates in accordance with the functional principle according to the invention. As drive sources, the hybrid motor vehicle HB has a fuel combustion engine CE and a first electric motor ISG for driving its powertrain PT. This first electric motor ISG is formed in particular by a so-called integrated starter generator which sits on the drive shaft of the powertrain PT. A clutch or coupling CL is provided in the powertrain PT between the crankshaft CS of the combustion engine CE and the first electric motor ISG. By means of this clutch CL, the combustion engine CE can be decoupled from the powertrain PT or connected to said powertrain in order to apply torque. In this way, the powertrain PT of the hybrid vehicle HB can advantageously be operated by the drive sources CE, ISG with different drive modes:
a) In the pure combustion mode of the hybrid vehicle HB the internal combustion engine CE alone is ready to drive the powertrain PT. Here, through the combustion of an air/fuel mixture, the pistons of the one or more cylinders CY of the combustion engine CE continuously drive the crankshaft CS thereof. The piston of each cylinder CY preferably passes through an intake phase or an intake stroke for sucking in air from an intake manifold IM of the combustion engine CE, a fuel proportioning and feeding phase such as e.g. through the injection of fuel, a compression phase, during which the air/fuel mixture is compressed and finally ignited in the respective cylinder, and an expansion phase, in which the heat released from the exothermic reaction of the air/fuel mixture is converted into a lifting movement of the piston of the respective cylinder and thereby into a torque on the crankshaft CS. In a modification to this, where the combustion engine is a so-called channel injector, the fuel is mixed with the air before it enters the respective cylinder. Of course, the combustion engine can also be operated using other different fuel combustion techniques. Liquid or gaseous fuels, or mixtures of the two, can preferably be used as fuel. To drive the powertrain PT of the hybrid vehicle HB, the rotating crankshaft CS is coupled to the powertrain PT for relaying torque through closing of the clutch CL and selection of a suitable gear by the downstream gear unit DR. With the aid of the gear unit or the transmission DR, different ratios can be set for the selected gears of a gear shift. The combustion engine CE can also be in combustion mode when idling, if e.g. the clutch CL is open or the gear unit DR occupies a gear-change position. When idling, the powertrain PT is not then driven by the rotating crankshaft CS of the combustion engine CE in combustion mode. The first electric motor or the first electric machine ISG between the clutch CL and the gear unit DR is deactivated while the combustion engine CE is in pure combustion mode and contributes nothing toward driving the powertrain PT. If it is fashioned as an integrated starter generator, then this integrated starter generator is during combustion mode in the powertrain switched in particular to passive.
b) When the hybrid vehicle HB is in pure electric drive mode, solely, i.e. exclusively the first electric motor ISG is ready to drive the powertrain PT. Here, the crankshaft CS of the combustion engine CE is decoupled from the powertrain PT by opening the clutch CL. With the aid of the gear unit DR arranged downstream of the first electric motor ISG, different ratios can be set for the selected gears of a gear shift. In this pure or solely electric operating mode of the hybrid motor vehicle HB, the combustion mode of the combustion engine CE is stopped or halted and its crankshaft CS is thus also stationary. The pure electric operating mode of the first electric motor also comprises a generator operating mode during which the first electric motor functions as a generator and produces a braking effect in respect of the powertrain PT.
c) When the hybrid vehicle is in mixed mode, or hybrid mode, both the combustion engine CE in combustion mode and the first electric motor ISG in electric drive mode are switched at the same time or simultaneously to active and are ready for driving the powertrain PT. This means that the combustion engine CE, through its fuel combustion process, sets its crankshaft CS continuously in rotation. The first electric motor ISG is connected to an energy storage device BAT such as e.g. a battery and can, if required, i.e. if a torque has to be applied to the powertrain, draw energy from this energy storage device. In mixed mode, it is then, for example, possible to couple these two drive units CE, ISG simultaneously to the powertrain PT in order to drive the powertrain PT actively, i.e. to set it into rotation. In detail, when a gear is selected in the gear unit DR to couple the crankshaft CS of the combustion engine CE to the powertrain PT, the clutch CL is closed, so as to connect the crankshaft of the combustion engine CE to the powertrain PT. At the same time, the first electric motor ISG on the powertrain PT is brought into its electric drive mode such that it is operatively connected to the powertrain. Of course, mixed mode also comprises other drive constellations in which the combustion engine CE and the electric motor ISG run simultaneously. Thus, for example, the powertrain PT can also be decoupled from these two running drive units CE, ISG when taking out of gear or when changing gear, i.e. shifting the gear unit DR to an idling position.

When the combustion engine CE is in pure combustion mode, air is sucked out of the intake manifold IM during the respective intake stroke of the respective cylinder CY through the open air-inlet valve thereof into its interior, such that a continuous reduced air pressure or a vacuum is provided in the intake manifold IM. The air feed into the intake manifold IM is regulated by a throttle valve TH in the intake area of the inlet aperture of the intake manifold IM. The position of the throttle valve TH is controlled by a control device ES, which is indicated in FIG. 1 by a control line L5. By means of an air-mass sensor SE2, the air mass sucked into the intake manifold IM is determined and a measurement signal representative thereof is transmitted to the control device ES via a measuring line L6. The respectively determined air-mass value serves in adjusting the throttle valve TH during the various cycles of the thermal combustion process of the cylinders CY of the combustion engine CE. At the same time, the respectively determined air-mass value constitutes an indirect measure of or an indirect measurement parameter for the reduced pressure generated in the intake manifold IM.

The intake manifold IM is connected via a vacuum line VL to the vacuum chamber VC of a brake booster BB of a hydraulic/mechanical brake system BS. A vacuum reservoir VR is additionally inserted into this vacuum line VL and assigned to the vacuum chamber VC of the brake booster BB as an upstream supplementary component. During the pure combustion mode of the hybrid vehicle HB, a gate/stop valve VE1 in the vacuum line VL upstream of the additional vacuum reservoir VR is opened such that the vacuum reservoir VR and the vacuum chamber VC of the brake booster BB are continuously through-connected to the interior of the intake manifold IM. Alternatively, the valve VE1 can also sit directly at the inlet to the additional vacuum reservoir VR. The opening of the valve VE1 can be carried out with the aid of the control device ES via a control line or a bus system L11. In this way, adequate reduced pressure for a desired boost of braking power can constantly be provided in the vacuum chamber VC of the brake booster BB during the pure combustion mode of the combustion engine CE. If the brake pedal BP on the brake booster BB is actuated, then by virtue of the reduced pressure in the vacuum chamber VC, the piston rod KS of the brake booster BB, to which the brake pedal BP is attached externally, can be displaced toward the hydraulic conversion part HD of the brake booster BB. Here, as a result of the suction effect of the reduced pressure in the vacuum chamber VC on a main braking cylinder BZ on the end of the piston rod KS facing away from the brake pedal BP an additional force is exerted in addition to the mechanical foot-pedal force and transferred to the hydraulic part HD of the brake booster BB. The hydraulic part HD is connected via one or more associated brake lines BL to mechanical brake components BR, in particular drum or disk brakes, on the wheels of the hybrid vehicle HB. For the sake of clarity in the drawings, these mechanical brake components BR are indicated in FIG. 1 merely by a rectangular frame. At least one control component can be interposed in the respective brake line BL in order to influence the braking effect. In the exemplary embodiment here, a control component DSM is included in the brake line BL. It exercises for example an ABS (antilock) function through automated brake actuation or a vehicle-stability function through intervention in the respective braking process.

Selection of the various drive modes of the hybrid vehicle HB is performed by the control device ES. In particular, it allows activation/deactivation and control of the torque of the combustion engine CE as well as of the first electric motor ISG as drive units. This open-loop or closed-loop control by the control device ES in respect of the combustion engine CE is indicated in FIG. 1 in a simplified manner by a direction-of-action or direction-of-control arrow L1 and in respect of the first electric motor ISG by a direction-of-action or direction-of control arrow L2. The control device ES also effects the opening and closing, i.e. expressed in general terms, the actuation of the clutch CL, which is symbolized by a direction-of-action or direction-of control arrow L3. With the aid of the control device ES′ gear-change commands can also be transmitted to the gear unit GR and implemented there. This is indicated in FIG. 1 by a further direction-of-action or direction-of control arrow L7.

To start the combustion process of the combustion engine CE, in FIG. 1 a so-called belt-driven starter generator RSG is provided as a second electric motor. It is likewise controlled with the aid of the control device ES, and this is illustrated by the direction-of-action or direction-of control arrow L4. The belt-driven starter generator RSG is coupled for this purpose via a belt BE to the crankshaft CS of the internal-combustion engine. The RSG serves principally to start rotating the combustion engine CE upon engine startup or to harness power for vehicle electrical components such as, for example, lights, control devices, electric pumps, and the like.

As soon as the combustion mode of the combustion engine CE is stopped or is otherwise inactive, the valve VE1 in the vacuum line VL upstream of the additional vacuum reservoir VR is closed, i.e. blocked. With the aid of the vacuum stored in the additional vacuum reservoir VR the vacuum chamber VC can then be supplied with an adequate reduced pressure for single or multiple actuation of the brake pedal BP. With the aid of a measuring unit SE1, in particular a pressure sensor, the reduced pressure IMP or a parameter representative hereof is measured in the additional vacuum reservoir VR and transmitted via a measuring line L8 to the control device ES for evaluation.

If the control device ES now switches for example from pure combustion mode to pure electric drive mode of the hybrid vehicle, i.e. it deactivates the combustion process of the combustion engine CE and activates the electric motor ISG for driving the powertrain PT, and if the control device ES registers that the measurement signals MS of the pressure sensor SE1, which signals it receives via the measuring line L8, indicate during or after single or multiple actuation of the brake pedal BP a reduced pressure in the additional vacuum reservoir VR, which reduced pressure drops to a predetermined lower limit or falls below said lower limit, then it activates the second electric motor RSG in order to set the crankshaft CS of the combustion engine CE into rotation and in order to generate a vacuum in the intake manifold IM. As soon as an adequate reduced pressure is available in the intake manifold IM, the control device ES causes the valve VE1 in the vacuum line VL to be opened so that the additional vacuum reservoir VR is connected through to the intake manifold IM. This makes it possible for the additional vacuum reservoir VR to be subjected to reduced pressure via the vacuum line VL of the intake manifold IM, in that when, during or after single or multiple actuation of the brake pedal BP, the reduced pressure in the vacuum reservoir VR drops to a predetermined lower limit or falls below said lower limit, when combustion mode is deactivated in pure electric drive mode of the hybrid vehicle, the crankshaft CS is rotated by means of at least one electric motor and in the process, a vacuum is generated in the intake manifold IM by the intake strokes of the cylinders CY. If it is established in the control device ES by means of the measurement signals MS recorded by the measuring unit SE1 that the reduced pressure in the additional vacuum reservoir VR again exceeds the predetermined lower limit by a specifiable factor, a control signal SS to close the valve VE1 is transmitted from the control device ES via the control line L11 to the valve VE1. An adequate reduced-pressure volume is then again available as a reserve in the vacuum reservoir VR for the renewed single or multiple actuation of the brake pedal BP of the brake booster BB. After this regeneration of an adequate reduced pressure in the additional vacuum reservoir VR, the second electric motor RSG is again stopped by the control device ES, i.e. the driving of the crankshaft CS is discontinued by the second electric motor RSG. Only when, with combustion mode deactivated in pure electric drive mode of the hybrid vehicle HB, the reduced pressure in the additional vacuum reservoir VR in turn reaches, during or after single or multiple actuation of the brake pedal BP of the brake booster BP, the predetermined lower limit or falls below said lower limit is the second electric motor RSG restarted to drive the crankshaft CS again, the valve VE1 in the vacuum line VL re-opened and consequently the vacuum reservoir VR subjected in turn to an adequate reduced pressure. Expressed in general terms, the combustion engine CE thus functions if required as a type of vacuum pump for the additional vacuum reservoir VR, in that, when combustion mode is deactivated, its crankshaft is subjected to a torque by an additional electric machine.

If braking is carried out in pure electric drive mode, then the first electric motor ISG is operated as a generator, resulting in a braking effect on the rotating powertrain PT. At the same time, electric power is stored recuperatively in the energy storage device BAT, in particular a battery. If the braking action produced by this recuperative braking process in the generator-operating mode of the first electric motor is not sufficient for the desired overall braking action of the hybrid vehicle HB, then the mechanical/hydraulic brake system BS sets in with its hydraulic/mechanical braking action on the powertrain PT. For this purpose, an adequate reduced pressure is initially available as a reserve in the vacuum chamber VC and in the vacuum reservoir VR for the single or multiple actuation of the brake pedal BP, so as to be able to provide trouble-free boosting of the braking power of the brake booster BB. In this braking phase, the valve VE1 in the vacuum line VL is closed. Only when it is established by means of the sensor SE1 in the control device ES that the reduced pressure in the vacuum reservoir VR has reached a critical lower limit or has even fallen below said lower limit, does the control device ES activate the second electric motor RSG for temporarily driving the crankshaft CS of the combustion engine CE and then open the valve VE1 in order to through-connect the intake manifold IM to the vacuum reservoir VR to apply a vacuum. The electrical energy for operating the second electric motor RSG is in this case preferably taken directly from the first electric motor ISG immediately because, as a generator, this first electric motor converts the rotational energy of the powertrain into electrical energy and thereby brakes the powertrain PT. For temporarily driving the crankshaft while driving the powertrain purely electromotively, the second electric motor can thus use portions of the electrical energy which is generated by the first electric motor ISG through its generator operation. This direct tapping of energy to a large extent advantageously avoids electrical energy losses. Alternatively, the second electric motor RSG can possibly take its electrical energy from an energy storage device such as e.g. BAT, in which electrical energy has been stored recuperatively during preceding regenerative braking processes and/or during the current regenerative braking process of the first electric motor ISG.

In this way, sufficient electrical energy is then available during the period in which the electric motor acts in a brake-like fashion for the powertrain as a generator and generates electrical energy recuperatively for driving the electric motor for auxiliary driving of the crankshaft of the combustion engine in an energy-efficient manner, if the reduced pressure in the additional vacuum reservoir of the brake booster exceeds an upper limit, i.e. the reduced pressure becomes too low there. This consequently makes it possible to maintain the functioning of the hydraulic/mechanical brake booster in pure electric drive mode of the hybrid vehicle to a large extent free of energy losses.

In the brake system BS shown in FIG. 1, it is not consequently necessary to install an additional electric vacuum or reduced-pressure pump on the intake manifold IM or on the brake booster BB itself, which pump would always be activated if insufficient reduced pressure were present in the brake system. In particular, to generate brake pressure in the brake line, a so-called active brake booster with an additional electric vacuum pump, which would additionally need a brake simulator for back-pressure on the brake pedal, is not necessary. By comparison, the brake system BS shown in FIG. 1 manages with simple, conventional components which are in any case already available for the hydraulic/mechanical brake system. This advantageously gives rise to savings in terms of weight and production/installation costs and to a fuel reduction.

Alternatively, it may optionally be useful to omit the second electric motor RSG for driving the crankshaft CS of the combustion engine CE and to apply a torque to the crankshaft CS with the aid of the first electric motor ISG, which serves in electrically driving the drive shaft of the powertrain PT, only when the reduced pressure in the vacuum reservoir drops to a predetermined reduced-pressure limit or falls below said lower limit. To this end, the clutch CL is usefully closed and coupled to the crankshaft CS during the period in which it is in generator-operating mode and the combustion engine CE is operated as a reduced-pressure pump for the additional vacuum reservoir VR, after the reduced pressure in the vacuum reservoir has dropped to the predetermined reduced-pressure limit or has fallen below said limit. Through the closing of the clutch CL, the combustion engine CE is now pulled up by the first electric motor ISG, in particular the integrated starter generator, to the driving torque thereof, whereby its activated motor drag torque additionally assists the braking. It may optionally be useful here to close the coupling smoothly in order largely to avoid unwanted load shocks produced by the coupling of the combustion engine CE to the powertrain.

Expressed in general terms, it is thus possible to couple one and the same electric motor which serves to apply torque to the powertrain PT in pure electric drive mode to the crankshaft CS of the combustion engine CE during regenerative braking when the braking action produced through the generator operation of this electric motor or the maximum power which can be output by the energy storage device BAT is not sufficient for a desired overall braking action and the existing hydraulic/mechanical brake system BS is therefore additionally actuated and in the process, through single or multiple pressing of the brake pedal BP, the vacuum in the vacuum chamber VC and in the associated additional vacuum reservoir VR reaches the predetermined lower limit or falls below said lower limit.

Furthermore, the combustion engine can, in accordance with the control principles indicated previously, be operated as a reduced-pressure pump for the brake booster of the hydraulic/mechanical brake system, optionally also in other drive modes or in other drive constellations or other power-train topologies, to provide a sufficient application of reduced pressure if the combustion process of the combustion engine itself is stopped or deactivated. The drive and brake concept described in relation to the variants in FIGS. 1 to 3 can thus advantageously also be used for a plurality of further power-train topologies, in which at least one combustion engine and at least one electric motor are provided for driving the powertrain and a hydraulic/mechanical brake system with a brake booster.

In the exemplary embodiment shown here in FIG. 1, the control device ES is fashioned as a central master control unit. In a modification hereto, it may optionally be useful to assign control-device functions which are assigned to the drive components and brake components of the hybrid motor vehicle to these individual components as separate control devices. For example, the first electric motor ISG and the second electric motor RSG will then each have their own control device.

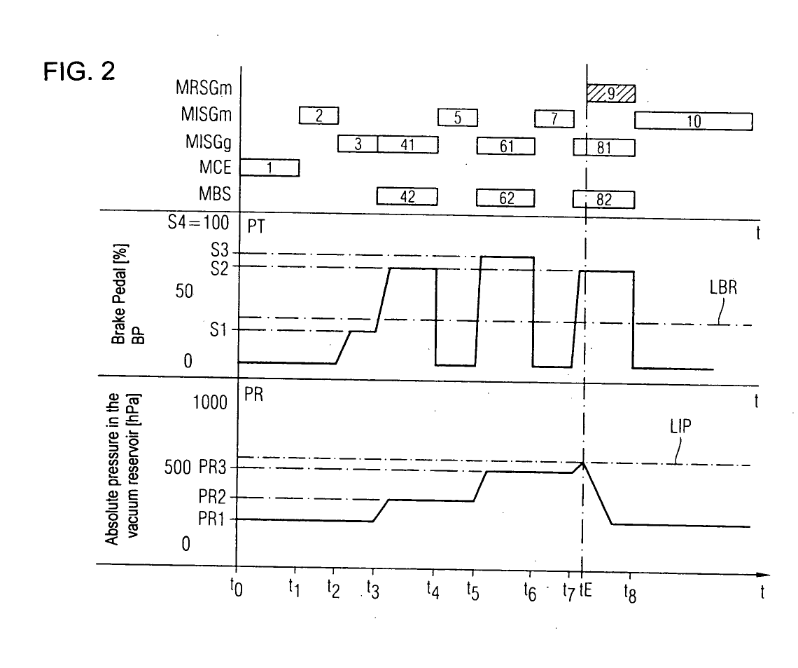

FIG. 2 illustrates in schematic representation various brake modes of the brake system BS for the hybrid motor vehicle HB shown in FIG. 1 and does so as a function of various drive modes of the drive units thereof, of the internal pressure of the additional vacuum reservoir VR for the brake booster BB and of the executed pedal position of the brake pedal BP. In detail, the top diagram shows various drive and brake states of the hybrid motor vehicle HB shown in FIG. 1 over the course of time t. The middle diagram in FIG. 2 indicates the pedal position PT of the brake pedal BP in per cent (%) relative to the end position thereof, which it reaches when depressed fully, with reference to the different drive and brake modes from the top diagram. Here the time t is again indicated along the x-axis. The bottom diagram in FIG. 2 reveals, matched to the curve of the brake pedal position PT, the course over time of the pressure PR in the vacuum reservoir VR in hectopascals (hPa) along the time axis t.

During the time span 1 from time t0 to time t1 the combustion engine CE exclusively, i.e. alone is running in pure combustion mode MCE. As a result, a reduced pressure or vacuum is generated continuously in the intake manifold IM. During this pure combustion mode MCE, the valve VE1 in the vacuum line VL is opened so that the additional vacuum reservoir VR and the vacuum chamber VC of the brake booster BB can be subjected to a reduced pressure such that the hydraulic/mechanical brake system is constantly ready to function, i.e. a desired boosting of braking power is permanently or constantly available upon actuation of the brake pedal. During this combustion mode, the suction of air from the intake manifold IM by the cylinders CY of the combustion engine CE is accompanied by a relatively low pressure PR1, preferably of 0 hPa, in the vacuum reservoir VR.

After this combustion mode MCE, the control device ES switches the type of drive of the hybrid motor vehicle HB to the pure electric drive mode for a time span or period 2. During this time span 2 between the times t1 and t2, the first electric motor ISG alone is operated in a motorized manner. Its torque alone is available for applying torque to the powertrain PT. This drive mode is designated MISGm in FIG. 2.

Starting from time t2, the driver of the hybrid vehicle HB now steps during its pure electric drive mode for the first time on the brake pedal BP and brings said brake pedal to brake-pedal position S1, which lies below a threshold value LBR. The first electric motor ISG switches over as a result to its generator-operating mode during which it acts as an electric brake. As long as the position PT of the brake pedal BP (here with PT=S1) lies below the threshold LBR, recuperative braking is carried out only with the aid of the first electric motor ISG and electrical energy is advantageously loaded into the energy storage device BAT. A certain braking-power effect, i.e. a certain counter-torque to the drive torque of the powertrain PT, is assigned to the position S1 of the brake pedal BP. In the exemplary embodiment shown here in FIG. 2, the brake pedal BP remains in the position SI until time t3. The purely recuperative braking process in the generator-operating mode is designated MISGg in FIG. 2. The time span between the times t2 and t3, during which the first electric motor ISG acts as an electric brake, is labeled in FIG. 2 with the numeral 3.

As of time t3, the brake pedal BP is, in continuation of this first braking process, depressed further such that the position PT=S2 of more than 50% of the total pedal displacement possible is reached and the threshold LBR is exceeded. As of the time as of which the threshold LBR is exceeded by the brake pedal displacement PT covered, the hydraulic/mechanical brake system BS is additionally activated and actuated by the control device ES. In other words, the braking action of the hydraulic/mechanical brake system BS, in addition to the electric braking action of the regeneratively operated first electric machine ISG, sets in at time t3 until time t4, as of which the brake pedal BP is fully let go or released. The brake mode for actuation of the hydraulic/mechanical brake system BS is designated MBS in FIG. 2. The time spans comprising the simultaneous braking action of the first electric machine ISG and of the hydraulic/mechanical brake system BS between times t3 and t4 are labeled by the numerals 41, 42. Actuation of the brake booster BB of the hydraulic/mechanical brake system BS as of time t3 decreases the reduced pressure in the vacuum reservoir VR, i.e. the air pressure PR there increases. In the exemplary embodiment shown here in FIG. 2, the pressure PR rises from an initial value PR1 to the higher air-pressure value PR2. During this combination or parallel operation of the regeneratively braking electric motor ISG and of the hydraulic/mechanical brake system BS, the valve VE1 in the vacuum line VL is blocked so that there is no through-connection to the intake manifold IM, and the combustion mode of the combustion engine CE is discontinued.

During the time span t4 to t5, the powertrain PT is in turn subjected to a drive torque by the electric motor ISG. This time span is labeled with the numeral 5. The brake pedal BP is fully released here, i.e. no braking is taking place.

At time t5, a new, second braking process is initiated. Here, the brake pedal BP is brought to a position BT=S3 which lies higher than the brake pedal position BT=S2. In other words, the brake pedal BP is thus now more heavily depressed toward its end position S4. In the process, the threshold LBR, which fixes the dividing line between pure electric braking and the combination of simultaneous activation of electric braking and hydraulic/mechanical braking, is exceeded. Braking is thus effected both by means of the regeneratively operated electric motor ISG during the time span 61 and simultaneously by means of the hydraulic/mechanical brake system BS during the temporally parallel time span 62. By this means, the reduced pressure in the additional vacuum reservoir VR weakens further. Viewed conversely, the air pressure PR in the vacuum reservoir VR increases to a value PR3 which is higher than the pressure value PR2 from the preceding first braking process.

After this second braking process, the brake pedal BP is in turn fully released during the time span 7 between times t6 and t7 and, is driven further through electric driving of the powertrain PT with the aid of the electric motor ISG.

At time t7, a third braking process is triggered in which the brake pedal is once again depressed beyond the threshold value LBR, as a result of which a combination or summation of electric braking through generator operation MISGg and through hydraulic/mechanical braking MBS of the brake system BS is triggered. Activation of the generator-operating mode is labeled 81 in FIG. 2 with 81 and activation of the hydraulic/mechanical brake system BS parallel thereto 82. Through such actuation of the brake booster BB three times, the internal pressure PR in the additional vacuum reservoir VR exceeds at time tE a predetermined upper limit LIP, as of which an adequate and desired boosting of braking power by the brake booster BB is no longer possible. Viewed conversely, the reduced pressure in the vacuum reservoir VR falls below a predetermined lower limit which is required for fault-free boosting of braking power by the brake booster BS. As of time t8, the brake pedal BP is finally fully let go, i.e. fully released and the electric drive mode MISGm continued by the electric motor ISG. This time span is labeled in FIG. 2 with the numeral 10.

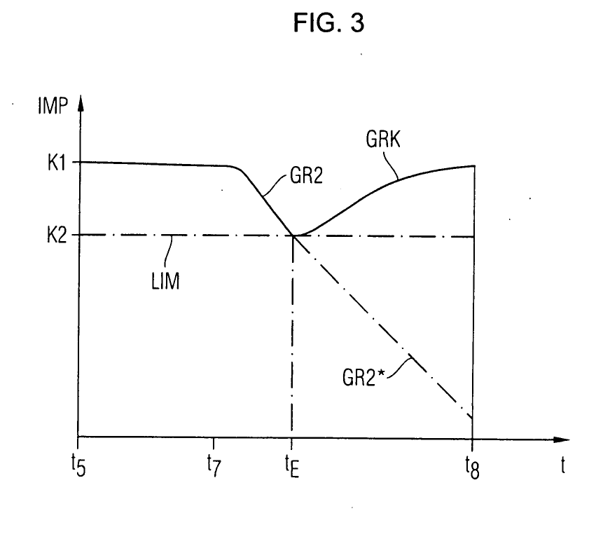

FIG. 3 illustrates with the aid of a reduced-pressure/time diagram a simplified time curve of the reduced pressure IMP in the intake manifold IM during the time span between times t5 to t8 from FIG. 2. As of time t7, as of which the brake booster BS has been actuated for the repeated, here third, time, the reduced pressure IMP falls from the level K1 to a level K2, which sets a lower limit for barely adequate brake boosting. This lower limit is labeled LIM in FIG. 3. The decreasing course of the reduced pressure IMP from the original level K1 to the lower level K2 is labeled GR2 in FIG. 3. The reduced pressure IMP reaches this lower limit at time tE. Thus, if in pure electric drive mode, in which only the first electric motor ISG is ready for driving the powertrain PT, the brake booster is actuated multiple times for example, then, without corrective action, the reduced pressure IMP in the vacuum reservoir VR and thus also in the vacuum chamber VC of the brake booster BD would fall below a lower limit LIM, as of which boosting of the braking power would be too weak or no longer possible at all. As of this time tE, as of which this lower limit LIM is fallen below, sufficient reduced pressure for further braking processes in which the brake booster is actuated, would no longer be available.

If the control device ES now establishes with the aid of the measurement signals MS of the measuring unit SE1 at the vacuum reservoir VR that the reduced pressure reaches the lower limit LIM or falls below said lower limit, then it activates at time tE the second electric motor RSG to drive the crankshaft CS of the combustion engine CE. Through the accompanying rotation of the combustion engine, air is sucked from the intake manifold IM and a reduced pressure consequently set up there. Simultaneously, the control device ES causes by means of at least one control signal SS via the control line L 1I the valve VE1 to be opened in the vacuum line VL upstream of the vacuum reservoir VR. The vacuum reservoir VR can by this means again be subjected to an adequate reduced pressure. The reduced pressure IMP is consequently again increased in the vacuum reservoir VR. This is illustrated in FIG. 3 by a rising curve GRK. Without this corrective action, i.e. without the temporary driving of the combustion engine CE in deactivated combustion mode by means of an electric machine, the internal pressure IMP in the vacuum reservoir would fall further and further such that the boosting of braking power by the brake booster would decline ever further. Only with activation of the combustion mode of the combustion engine would it again be possible to subject the vacuum reservoir VR to an adequate reduced pressure. However, this would impair too severely the braking-function reliability of the hybrid vehicle during pure electric drive mode. The decreasing curve (without corrective action) for the reduced pressure IMP is labeled GR2* in FIG. 3 and is inscribed as a dot-dash line. In that, however, as of time tE the combustion engine CE is temporarily driven with the aid of the second electric machine RSG and is operated as a substitute reduced-pressure or vacuum pump, and the valve VE1 is opened, the vacuum in the vacuum reservoir VR is increased again, i.e. the pressure PR there decreases again. Thus, in the bottom diagram in FIG. 2 the air pressure PR in the vacuum reservoir falls again to its original starting level PR1. As soon as it has reached this, the second electric machine RSG is stopped again so that no further electrical energy is taken from the energy storage device BAT or directly from the first electric machine ISG.

This corrective, i.e. auxiliary driving of the crankshaft CS with the aid of at least one electric machine makes it possible even during the pure electric drive mode of the hybrid vehicle to ensure to a large extent that a reduced pressure IMP above a lower limit LIM is provided in the vacuum reservoir VR, as is required for an adequate boosting of braking power by the brake booster BB.

Viewed in summary, at least one electric machine is thus provided in the powertrain in hybrid vehicles with the facility for operating electrically. In particular, the presence of at least one first and at least one second electric machine is advantageous. A second such electric machine may for example be formed by an electric motor for starting the internal combustion engine (starter). If the internal combustion engine is now deactivated, as for example in electric drive mode, the crankshaft of the internal combustion engine can be rotated with the aid of the second electric machine, but without fuel injection. In this way, with the throttle valve largely closed, a reduced pressure is generated in the intake manifold, which pressure is required in the brake system for an adequate boosting of braking power. The internal combustion engine is consequently not started, i.e. no thermal combustion process is initiated.

Alternatively, this facility for generating reduced pressure is optionally also possible with only one single electric machine. The electric machine in the drive then provides a drive torque both for the crankshaft of the internal combustion engine and for the powertrain. Through the closing of the clutch CL, the combustion engine CE is now pulled up by the first electric motor ISG, in particular the integrated starter generator, to the drive torque thereof, whereby its activated motor drag torque additionally assists the braking, since it counters the drive torque of the first electric motor ISG.

It is particularly advantageous that existing components of the hybrid vehicle will suffice for generating an adequate reduced pressure and thus for fault-free operation of the brake booster even when the combustion engine is deactivated. In this way, it is not necessary to provide additional components for supporting the braking power such as, for example, an electric vacuum pump or an active brake booster with its own assigned vacuum pump, rather the existing components of the hybrid motor vehicle which are present in any case will suffice for maintaining an adequately high reduced pressure for the brake booster, if the combustion mode of the combustion engine is stopped. For example, in the case of the so-called parallel hybrid drive concept for a motor vehicle, an electric motor, in particular a belt-driven starter generator, is used for starting its combustion engine or for generating power. An additional electric motor, in particular a so-called integrated starter generator, serves for generating power, for boosting—i.e. supporting the combustion engine in drive mode—, and/or for pure electric driving and for compensating irregular running of the combustion engine as a result of individual cylinder pressure peaks. The belt-driven starter generator can then if required advantageously be used as an electric machine for the auxiliary driving of the combustion engine to generate reduced pressure when combustion mode is deactivated.

In the exemplary embodiment shown in FIGS. 1 to 3, the clutch CL is open in electric drive mode and the integrated starter generator ISG delivers the drive torque for the powertrain PT. In a case where the reduced brake pressure falls below a certain threshold, the combustion engine CE is driven by way of substitution using the belt-driven starter generator RSG. However, no fuel is injected into the cylinders CY thereof. The combustion engine CE generates here a reduced pressure in the intake manifold IM which can be used for the brake booster BB. It is not necessary for reduced pressure to be constantly topped up since the brake booster has the additional vacuum reservoir VR. In particular, such a reserve of reduced pressure is stored there that this reserve will suffice for at least one to two braking processes. Further components for generating the reduced pressure are not needed in this case.

In a modification to the exemplary embodiment shown in FIG. 1, it may optionally also be useful to determine the reduced pressure IMP in the additional vacuum reservoir VR by means of a pressure sensor which is assigned to the vacuum chamber VC of the brake booster BB.

Alternatively, it may optionally suffice to omit the measuring unit SE1 completely and to determine the internal pressure in the vacuum reservoir through auxiliary parameters. Thus, for example, a representative measure of the internal pressure IMP can be derived by determining during pure electric drive mode how often the brake booster has already been put into service. As an alternative to this, information about the current internal pressure in the vacuum reservoir can be derived from how often the brake pedal has already exceeded the threshold value LBR during pure electric drive mode. Furthermore, the current internal pressure in the vacuum reservoir can be estimated by evaluating the current mechanical brake-pedal position, the vehicle speed, the gear selection, vehicle mass and inclination of the roadway. The inclination of the roadway can advantageously be determined either with an inclination angle sensor or via a navigation system with position-determining function.

Furthermore, the respective additional vacuum reservoir can optionally also be an integral part of the brake booster. In this way, the vacuum chamber thereof can in particular also be upgraded to a vacuum reservoir which can accommodate sufficient reduced pressure for one or more braking processes during the pure electric drive mode. In addition, two or more vacuum reservoirs can also be provided for the brake booster.

1. A brake system with a brake booster for a hybrid motor vehicle having at least one combustion engine with an intake manifold and at least one electric motor for driving a powertrain of the motor vehicle, comprising:
at least one additional vacuum reservoir for a vacuum chamber of the brake booster;
at least one electric motor for subjecting the at least one additional vacuum reservoir to reduced pressure via at least one vacuum line of the intake manifold by temporarily driving the crankshaft of the combustion engine when combustion mode is deactivated and the hybrid vehicle is in pure electric drive mode, said at least one electric motor generating the reduced pressure in the intake manifold only when a reduced pressure in the vacuum reservoir of the brake booster drops to a predetermined lower limit or falls below the lower limit during or following single or multiple actuation of the brake pedal.

2. The brake system according to claim 1, wherein said electric motor that serves to temporarily drive the crankshaft of the combustion engine, when combustion mode is deactivated, to generate reduced pressure in the intake manifold, is provided in addition to the electric motor that serves to drive the powertrain of the hybrid vehicle.

3. The brake system according to claim 2, wherein the electric motor that serves to drive the powertrain of the hybrid vehicle, is an integrated starter generator on the drive shaft of the powertrain.

4. The brake system according to claim 2, wherein said electric motor that serves to temporarily drive the crankshaft of the combustion engine, when combustion mode is deactivated, to generate reduced pressure in the intake manifold, is a belt-driven starter generator.

5. The brake system according to claim 1, wherein the electric motor that serves to drive the powertrain of the hybrid vehicle simultaneously forms said electric motor for temporarily driving the crankshaft of the combustion engine, when combustion mode is deactivated, to generate reduced pressure in the intake manifold.

6. The brake system according to claim 1, which comprises a control device for activating the electric motor for temporarily driving the crankshaft of the combustion engine only when the reduced pressure which a measuring unit measures directly in the additional vacuum reservoir of the brake booster or for which a representative measure has been derived indirectly from one or more auxiliary parameters reaches or falls below the predetermined lower limit for the reduced pressure in the additional vacuum reservoir.

7. The brake system according to claim 1, wherein the throttle valve in the intake area of the intake manifold is largely closed when the electric motor for temporarily driving the crankshaft of the combustion engine is started to generate reduced pressure.

8. The brake system according to claim 1, which comprises at least one clutch disposed between the combustion engine and a gear unit arranged downstream in the powertrain, said at least one clutch, when combustion mode of the combustion engine is deactivated, disengaging a crankshaft of the combustion engine from the powertrain.

9. The brake system according to claim 8, wherein, when combustion mode of the combustion engine is deactivated, the powertrain is driven by an electric motor.

10. The brake system according to claim 9, wherein said electric motor is an integrated starter generator disposed between said clutch and the gear unit on the powertrain.

11. The brake system according to claim 1, which further comprises a gate valve upstream of said additional vacuum reservoir in the vacuum line or at an inlet to said additional vacuum reservoir, said gate valve is opened in pure electric drive mode only when, during or after single or multiple actuation of the brake pedal, the predetermined lower limit of the reduced pressure in the vacuum reservoir of the brake booster is reached or undershot and a desired reduced pressure has thereupon been set up in the intake manifold of the combustion engine through the temporary driving of the crankshaft thereof with the aid of said electric motor.

12. A method for maintaining a functionality of a brake system of a hybrid motor vehicle, the brake system having a brake booster and the hybrid motor vehicle having at least one combustion engine with an intake manifold and at least one electric motor for driving a powertrain, the method which comprises:
in pure electric drive mode of the hybrid vehicle when combustion mode is deactivated, subjecting at least one additional vacuum reservoir for the vacuum chamber of the brake booster to reduced pressure only when, during or after single or multiple actuation of the brake pedal thereof, the reduced pressure in the additional vacuum reservoir of the brake booster drops to a predetermined lower limit or falls below the lower limit, via at least one vacuum line from the intake manifold, by temporarily driving the crankshaft of the combustion engine with at least one electric motor for generating reduced pressure in the intake manifold.

13. The method according to claim 12 carried out on a brake system according to claim 1.

14. The method according to claim 12, which comprises opening a gate valve in the vacuum line for supplying reduced pressure to the additional vacuum reservoir only when, during or after single or multiple actuation of the brake pedal, the predetermined lower limit of the reduced pressure in the vacuum reservoir of the brake booster has been reached or undershot and a desired reduced pressure has thereupon been established in the intake manifold of the combustion engine through the temporary driving of the crankshaft thereof with the aid of the electric motor.

15. A control device for maintaining a functionality of a brake system for a hybrid motor vehicle having at least one combustion engine with an intake manifold and at least one electric motor for driving powertrain of the motor vehicle, the control device comprising:
control means for subjecting at least one additional vacuum reservoir for a vacuum chamber of the brake booster, when combustion mode is deactivated in pure electric drive mode of the hybrid vehicle, to reduced pressure only when, during or after single or multiple actuation of the brake pedal thereof, the reduced pressure in the additional vacuum reservoir of the brake booster drops to a predetermined lower limit or falls below said lower limit, via at least one vacuum line from the intake manifold by causing at least one electric motor for generating reduced pressure in the intake manifold to only temporarily drive the crankshaft of the combustion engine.

16. The control device according to claim 15 configured to control the brake system according to claim 1.
